(19) United States
(12) Patent Application Publication
(10) Pub. No.: US 2023/0275309 A1
(43) Pub. Date: Aug. 31, 2023

(54) BATTERY ASSEMBLY VENT VALVE HAVING A BREATHABLE MEMBRANE

(71) Applicant: Ford Global Technologies, LLC, Dearborn, MI (US)

(72) Inventors: Tao Shen, Nanjing (CN); Xiuhua Zhang, Nanjing (CN); Kevin Cheng, Nanjing (CN)

(21) Appl. No.: 18/163,368

(22) Filed: Feb. 2, 2023

(30) Foreign Application Priority Data
Feb. 25, 2022 (CN) 202210180136X

(51) Int. Cl. H01M 50/317; H01M 50/30

(52) U.S. Cl. CPC H01M 50/317; H01M 50/394; H01M 2200/20; H01M 2220/20

(57) ABSTRACT

A vent valve includes a breathable membrane. The vent valve can be in a battery assembly of a vehicle. The vent valve comprises a base defining a central channel and a valve core movably connected with the base and including at least one first gas channel. The valve core is configured to move from a first position to a second position relative to the base under a gas pressure. When the valve core is in the second position, the first gas channel is at least partially opened to allow some airflow to bypass the breathable membrane.

### CROSS-REFERENCE TO RELATED APPLICATIONS

This disclosure claims priority to Chinese Patent Application No. 202210180136X, which was filed on 25 Feb. 2022 and is incorporated herein by reference in its entirety.

### TECHNICAL FIELD

The present disclosure relates to a vent valve including a breathable membrane, a battery assembly including this vent valve, and a vehicle.

### BACKGROUND

Vent valves are widely used in battery packs of electric vehicles to ensure that pressure inside and outside the battery packs is balanced under any circumstances.

Spring-opened vent valves are widely used in the current market. For example, CN205388172U discloses a one-way safety valve and a battery containing this safety valve, in which a piston is pressurized by a spring.

### SUMMARY

The disclosure summarizes aspects of the embodiments and should not be used to limit the claims. Other implementations are contemplated in accordance with the techniques described herein, as will be apparent upon examination of the following drawings and detailed description, and such implementations are intended to be within the scope of this application.

According to a first aspect of the present disclosure, a vent valve including a breathable membrane is provided. The vent valve comprises a base defining a central channel, and a valve core movably connected with the base and including at least one first gas channel. The valve core is configured to move from a first position to a second position relative to the base under a gas pressure. When the valve core is in the second position, the first gas channel is at least partially opened to allow at least some airflow to bypass the breathable membrane.

In an embodiment of the present disclosure, the vent valve further comprises a cover connected with the base and including at least one second gas channel. When the valve core is in the second position, the central channel, the first gas channel and the second gas channel are in fluid communication.

In an embodiment of the present disclosure, the cover defines a maximum displacement of the valve core relative to the base.

In an embodiment of the present disclosure, the valve core has a side wall contained in the central channel and an opening surrounded by the side wall. The breathable membrane covers the opening and the first gas channel is formed on the side wall.

In an embodiment of the present disclosure, the valve core comprises a first end formed by extension of the side wall. The first end is configured to move away from the base while the valve core moves from the first position to the second position relative to the base. The first gas channel is arranged on the side wall of the valve core near the first end.

In an embodiment of the present disclosure, the valve core has a side wall containing the central channel and an opening surrounded by the side wall. The breathable membrane covers the opening, and the first gas channel is formed on the side wall.

In an embodiment of the present disclosure, the valve core is configured to at least partially maintain connection with the central channel when it is in the second position.

In an embodiment of the present disclosure, the vent valve further comprises a retaining member. The valve core is movably connected with the base through the retaining member, and the retaining member is configured to maintain the valve core at least in the first position.

In an embodiment of the present disclosure, the retaining member comprises a connecting part and an extension part extending from the connecting part. The extension part has at least one protrusion. The connecting part is connected with one of the valve core and the base, and the other of the valve core and the base includes at least one recess corresponding to the at least one protrusion. The protrusion is configured to engage with the recess to maintain the valve core in the first position.

In an embodiment of the present disclosure, the recess is configured to be separated from the protrusion when the valve core moves from the first position to the second position relative to the base.

In an embodiment of the present disclosure, one of the valve core and the base includes a retaining part, and the other of the valve core and the base includes a matching part corresponding to the retaining part.

In an embodiment of the present disclosure, the retaining part and the matching part are configured to maintain the valve core at least in the first position through interference fit or friction fit.

In an embodiment of the present disclosure, the vent valve further comprises a seal arranged between the valve core and the base.

In an embodiment of the present disclosure, the valve core moves in a first direction relative to the base, and when the valve core is in the second position, the at least part of the airflow flows through the first gas channel in a second direction different from the first direction.

In an embodiment of the present disclosure, the first direction is perpendicular to the second direction.

According to a second aspect of the present disclosure, a battery assembly is provided. The battery assembly comprises a battery cell shell configured to accommodate battery cells. The battery cell shell has an opening. The assembly further includes a vent valve including a breathable membrane and connected with the battery cell shell through the opening. The vent valve includes a base defining a central channel, and a valve core movably connected with the base and including at least one first gas channel. The valve core is configured to move from a first position to a second position relative to the base under a gas pressure. When the valve core is in the second position, the first gas channel is at least partially opened to allow some airflow to bypass the breathable membrane.

In an embodiment of the present disclosure, the vent valve further comprises a cover connected with the base and including at least one second gas channel. When the valve core is in the second position, the central channel, the first gas channel and the second gas channel are in fluid communication.

In an embodiment of the present disclosure, the vent valve further comprises a retaining member, the valve core is movably connected with the base through the retaining member, and the retaining member is configured to maintain the valve core at least in the first position.

In an embodiment of the present disclosure, the battery assembly further comprises a first seal arranged between the valve core and the base, and a second seal arranged between the base and the battery cell shell.

According to a third aspect of the present disclosure, a vehicle includes the battery assembly as described in the present disclosure is provided.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the figures, like reference numbers refer to like parts throughout the different figures, in which:

FIG. 1 shows a schematic diagram of an exemplary vehicle;

FIG. 2 shows a sectional schematic diagram of an exemplary vent valve according to an embodiment of the present disclosure;

FIG. 3 shows another sectional schematic diagram of the exemplary vent valve of FIG. 2;

FIG. 4 shows a sectional schematic diagram of an exemplary vent valve according to another embodiment of the present disclosure;

FIG. 5 shows another sectional schematic diagram of the exemplary vent valve of FIG. 4;

FIG. 6 shows a sectional schematic diagram of an exemplary vent valve according to yet another embodiment of the present disclosure;

FIG. 7 shows another sectional schematic diagram of the exemplary vent valve of FIG. 6;

FIG. 8 shows another sectional schematic diagram of an exemplary vent valve according to yet another embodiment of the present disclosure;

FIG. 9 shows another sectional schematic diagram of an exemplary vent valve according to yet another embodiment of the present disclosure;

FIG. 10 shows another sectional schematic diagram of an exemplary vent valve according to yet another embodiment of the present disclosure;

FIG. 11 shows another sectional schematic diagram of an exemplary vent valve according to yet another embodiment of the present disclosure; and

FIG. 12 shows a sectional schematic diagram of an exemplary battery assembly according to an embodiment of the present disclosure.

### DETAILED DESCRIPTION

Embodiments of the present disclosure are described below. However, it should be understood that the disclosed embodiments are only examples, and other embodiments may take various alternative forms. Drawings are not necessarily drawn to scale; and some functions may be exaggerated or minimized to show details of specific components. Therefore, the specific structural and functional details disclosed herein should not be interpreted as restrictive, but merely as a representative basis for teaching those skilled in the art to use the present disclosure in various ways.

Various features shown and described with reference to any one of the drawings may be combined with features shown in one or more other drawings to produce embodiments which is not explicitly shown or described. The combination of the features shown provides a representative embodiment for a typical application. However, various combinations and modifications of features consistent with the teachings of the present disclosure may be expected for certain specific applications or embodiments.

Further, in this document, relational terms, such as first and second and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The motor vehicle involved in the following embodiments can be standard gasoline powered vehicle, hybrid electric vehicle (HEV), electric vehicle (BEV), plug-in hybrid electric vehicle (PHEV), full hybrid electric vehicle (FHEV), fuel cell vehicle and/or any other type of vehicles, as well as bus, ship or aircraft. The vehicle includes components related to mobility, such as engine, electric motor, transmission, suspension, drive shaft and/or wheels, etc. The vehicle can be nonautonomous, semi-autonomous (for example, some conventional motion functions are controlled by the vehicle) or autonomous (for example, motion functions are controlled by the vehicle, without direct input from driver).

According to a first aspect of the present disclosure, a vent valve including a breathable membrane is provided. The vent valve comprises a base defining a central channel and a valve core movably connected with the base and including at least one first gas channel. The valve core is configured to move from a first position to a second position relative to the base under a gas pressure. When the valve core is in the second position, the first gas channel is at least partially opened to allow some airflow to bypass the breathable membrane. In a normal working state of a battery, that is, in a non-exhaust state of the battery, the vent valve provided by the present disclosure can provide internal and external pressure balance channels to balance the pressure caused by temperature and altitude changes. In an abnormal working state of the battery, that is, in an exhaust state of the battery, internal pressure rise due to the battery exhaust, which causes the valve core to move, and the exhaust can escape through the first gas channel, thus realizing rapid pressure release inside the battery and ensuring safety.

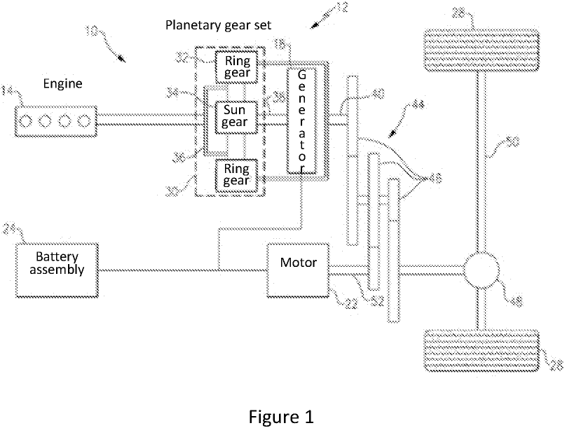

Referring to FIG. 1, one example of a vehicle 12 is shown. Although depicted as a hybrid electric vehicle (HEV), it should be understood that the present disclosure may be applied to other types of electrified vehicle, such as plug-in deep hybrid electric vehicles (PHEV), pure electric vehicles (BEV), full hybrid electric vehicles (FHEV), etc.

In one embodiment, a powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery assembly 24. In this example, the second drive system is considered an electric drive system of the powertrain 10. The first and second drive systems generate torque to drive one or more sets of vehicle drive wheels 28 of the vehicle 12. Although a power-split configuration is shown in this illustrative embodiment of FIG. 1, this disclosure extends to any hybrid electric vehicle including full hybrids, parallel hybrids, series hybrids, mild hybrids or micro hybrids. The engine 14 and the generator 18 may be connected through a power transfer unit 30. In addition to planetary gear set, other types of power transfer units may be used to connect the engine 14 to the generator 18. In a non-limiting embodiment, the planetary gear set includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The battery assembly 24 is an example type of battery assembly for electric vehicles. The battery assembly 24 may provide power to drive a motor, and in regenerative braking, the motor 22 and generator 18 may output power to the battery assembly 24 for storage. The battery assembly 24 may include a high voltage battery pack, which may include a plurality of battery arrays. The battery assembly 24 can also include a vent valve containing a breathable membrane. In the following embodiments, vent valves containing a breathable membrane that can be incorporated into the battery assembly 24 in the above example are provided.

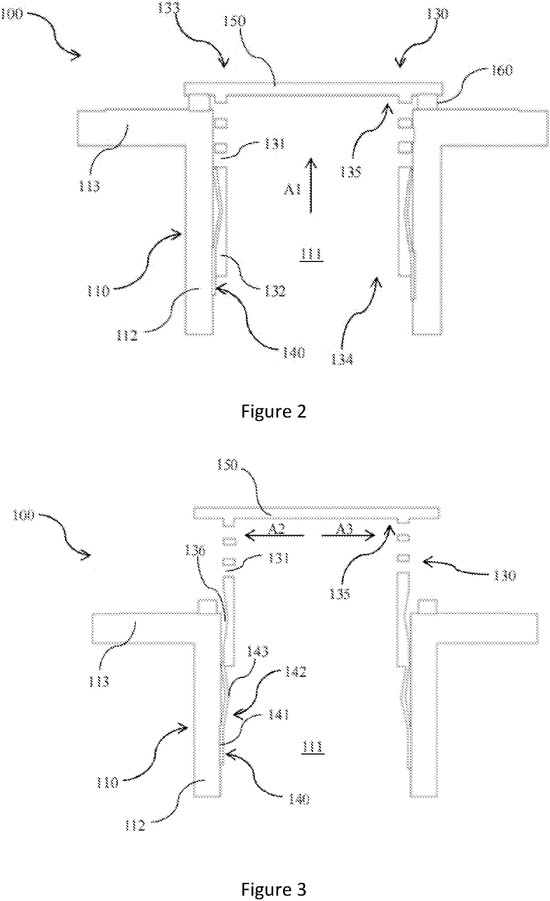

FIGS. 2 and 3 are schematic diagrams of a vent valve 100 including a breathable membrane 150 that can be incorporated into the battery assembly 24 according to an embodiment of the present disclosure. As shown in FIGS. 2 and 3, the vent valve 100 may include a base 110 defining a central channel 111 and a valve core 130 movably connected to the base 110. The base 110 may be a cylinder, which may include a side wall 112. In other embodiments, the base 110 can also be a structure of other shapes, which is not limited here. Optionally, the base 110 may also include a flange 113 extending from the side wall 112, which may be used to connect the vent valve 100 to the battery assembly and/or other components, as described in other parts of the present disclosure.

The valve core 130 may include a side wall 132 contained in the central channel 111 and at least one first gas channel 131 disposed on the side wall 132. The first gas channel 131 can be arranged on the side wall 132 in a regular arrangement, such as fixed row and column spacing, or can be arranged on the side wall 132 in an irregular arrangement, or in a combination of regular and irregular arrangement. In the embodiment of FIG. 2, three first gas channels 131 are shown. However, one or other number of gas channels can be provided as required, which is also included in the scope of the present disclosure. The valve core 130 further comprises an opening 135 surrounded by the side wall 132. In the embodiment shown in FIGS. 2 and 3, the opening 135 is completely covered by the breathable membrane 150. The breathable membrane 150 can be a gas-permeable elastic membrane, which can provide normal gas flow under the normal working state of the battery to provide internal and external pressure balance. The breathable membrane 150 may include a polytetrafluoroethylene membrane. In other embodiments, the breathable membrane of other materials that can realize the passage of gas is also included in the scope of the present disclosure.

In the embodiment shown in FIGS. 2 and 3, the valve core 130 may include a first end 133 formed by the extension of the side wall 132. The first end 133 may be configured to move away from the base 110 when the valve core 130 moves from a first position to a second position relative to the base 110, and the first gas channel 131 may be arranged on the side wall 132 of the valve core 130 near the first end 133. In addition, although FIGS. 2 and 3 show that the breathable membrane 150 is located at the first end 133, in other embodiments, the breathable membrane 150 can also be located at a second end 134 opposite to the first end 133.

The valve core 130 can be movably connected with the base 110 through an additional retaining member 140, so that the valve core 130 can move from the first position to the second position relative to the base 110 under a gas pressure. The embodiment of FIG. 2 shows a schematic diagram of the valve core 130 in the first position. In this embodiment, the retaining member 140 may include a connecting part 141 and an extension part 142 extending from the connecting part 141, and the extension part 142 may have a protrusion 143. Although the specific structure of the retaining member 140 is shown in FIG. 2 and only one protrusion 143 is shown, the retaining member of other structures can be provided and the retaining member can include a plurality of protrusion as required. The retaining member 140 may be made of plastic or metal, and the retaining member 140 may be integrally formed with the base 110 (such as by injection molding) or connected to the side wall of the base 110. In the embodiment of FIG. 2, the connecting part 141 can be connected to the side wall 112 of the base 110, for example, by welding, bonding, bolting, etc., and the side wall 132 of the valve core 130 can include a recess 136 corresponding to the protrusion 143. The protrusion 143 can be configured to engage with the recess 136 to maintain the valve core 130 in the first position shown in FIG. 2. The recess 136 can be configured to be separate from the protrusion 143 when the valve core 130 moves from the first position to the second position relative to the base 110, as described in other parts of the present disclosure. It should be understood that although it is shown in FIG. 1 that the connecting part 141 of the retaining member 140 is connected with the base 110 and the valve core 130 includes a recess 136, in another embodiment, the connecting part 141 can be connected with the valve core 130, and the recess 136 can be arranged on the base 110, further, the recess 136 can be replaced by hole, and the extension part 142 can be a component extending horizontally from the connecting part 141, and is provided with a round, semicircle, triangular, conical, truncated cone or other shaped protrusion that can match the hole. These structures and the combination of structures are also included in the scope of the present disclosure.

In the embodiment of the present disclosure, optionally, the vent valve 100 further comprises a seal 160 arranged between the valve core 130 and the base 110, which is used to seal mating surfaces between the valve core 130 and the base 110 and prevent water vapor or foreign matter from entering the vent valve. The seal 160 can be an O-ring, and other seals that can achieve the sealing function are also within the scope of the present disclosure. In the embodiment shown in FIGS. 2 and 3, the seal 160 is arranged at the top of the base 110. When the valve core 130 is in the first position shown in FIG. 2, the seal 160 seals the mating surfaces between the valve core 130 and the base 110. When the valve core 130 is in the second position shown in FIG. 3, the seal 160 is separated from the valve core 130.

In the normal working state of the battery, that is, in the non-exhaust state of the battery, the valve core 130 is usually in the first position shown in FIG. 2, the first gas channel 131 is blocked by the side wall 112 of the base 110, airflow entering the central channel 111 can be discharged through the breathable membrane 150, but cannot flow through the first gas channel 131. In the abnormal working state of the battery, that is, in the exhaust state of battery, internal pressure rise due to the battery exhaust, and the pressure accumulated to a certain extent causes the connection between the recess 136 and the protrusion 143 of the valve core 130 to “broken”, so that the valve core 130 moves to the second position relative to the base 110 in a direction parallel to the central channel 111 as shown by arrow A1. In the second position, the first gas channel 131 is at least partially opened to allow at least part of the airflow to bypass the breathable membrane 150, and in the second position, the valve core 130 can be configured to at least partially maintain the connection with the central channel 111, thus avoiding the separation of the valve core 130 from the base 110. FIG. 3 shows an exemplary second position. In this second position, the first gas channel 131 is no longer blocked, but can allow the airflow to pass through. Therefore, a large amount of airflow entering the central channel 111 can flow through the first gas channel 131 in the direction shown by arrow A2 or arrow A3, and bypass the breathable membrane 150, so that a large amount of gas can be rapidly discharged in a short time. In the embodiment shown in FIGS. 2 and 3, the direction shown by arrow A1 is perpendicular to the direction shown by arrow A2 and arrow A3.

In the second position as shown in FIG. 3, the first gas channels 131 are all not blocked and the airflow is allowed to pass through. However, in other embodiments, when the accumulated pressure is small, the valve core 130 can move relative to the base 110 to a second position where only some of the first gas channels 131 are not blocked and the airflow is allowed to pass through, at this second position, there are still some of the first gas channels 131 are blocked and the air flow is not allowed to pass through. Therefore, the degree of movement of the valve core 130 relative to the base 110 and the proportion of the first gas channel 131 allowing the airflow to pass through are proportional to the pressure that push the valve core 130 to move.

In the embodiment of the present disclosure, when a large amount of gas is accumulated in the battery assembly in a short time, a large amount of gas will quickly enter the central channel 111. In this case, the vent valve described in the present disclosure can respond quickly and move rapidly under the action of gas pressure, so that a large amount of gas can be discharged through the first gas channel on the valve core.

Those skilled in the art should understand that the above only shows the structure of the vent valve by way of example, but the present disclosure can also include vent valves of other structures, and the valve core can be flexible or non-flexible parts. For example, in a patent application with the application number of WO202111474127.3 and the invention name of “a vent valve for battery pack and battery pack”, a vent valve, which includes flexible element, is provided. As an alternative to the valve core disclosed by the present disclosure, the technical solution of the present disclosure can include the flexible element disclosed in the above application, for example, providing a gas channel on the compression part of the flexible element, when the flexible element moves under the action of gas pressure, the gas channel provided on the compression part of the flexible element can also discharge a large amount of gas, thus also realizing the technical effect of the present disclosure. The above application is incorporated into the present disclosure by reference in its entirety.

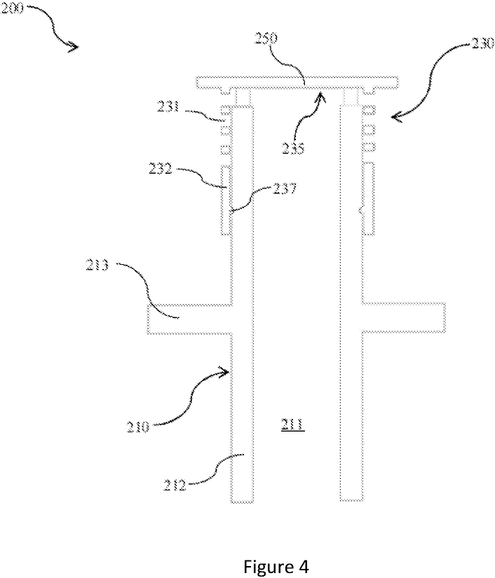

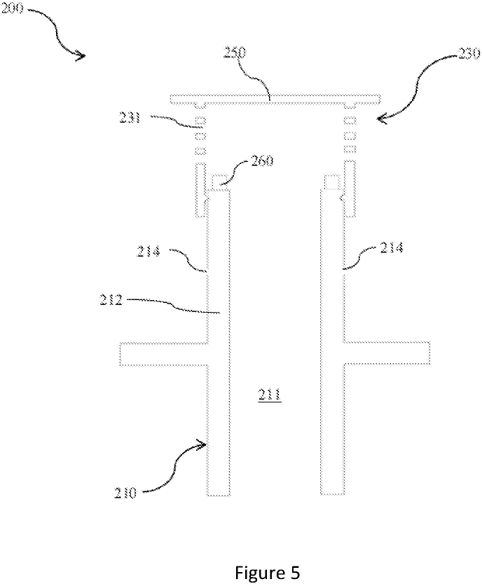

FIGS. 4 and 5 are schematic diagrams of a vent valve 200 including a breathable membrane 250 that can be incorporated into the battery assembly 24 according to another embodiment of the present disclosure. Similar to the vent valve 100, the vent valve 200 may include a base 210 defining a central channel 211 and a valve core 230 movably connected to the base 210. The base 210 may include a side wall 212. Optionally, the base 210 may also include a flange 213 extending from the side wall 212, which may be used to connect the vent valve 200 to the battery assembly and/or other components.

The valve core 230 may include a side wall 232 configured to accommodate the central channel 211 and at least one first gas channel 231 arranged on the side wall 232. The valve core 230 further comprises an opening 235 surrounded by the side wall 232. In the embodiment shown in FIGS. 4 and 5, the opening 235 is completely covered by the breathable membrane 250.

Unlike the vent valve 100, as an alternative to the additional retaining member, one of the valve core 230 and the base 210 can include a retaining part, and the other of the valve core 230 and the base 210 can include a matching part corresponding to the retaining part, so that the valve core 230 can move from a first position to a second position relative to the base 210 under the gas pressure. In the embodiment of the present disclosure, the retaining part and the matching part can be configured to maintain the valve core 230 at least in the first position through interference fit or friction fit. In the embodiment shown in FIGS. 4 and 5, the retaining part can be embodied, for example, as a hole 214 arranged on the side wall 212 of the base 210, and the matching part can be embodied, for example, as a protrusion 237 arranged on the side wall 232 of the valve core 230. It should be understood that the retaining part can also be a recess, and the matching part can also have other shapes other than the semicircle shown, such as round, triangle, cone, truncated cone or other shapes that can match the hole or recess. In addition, the retaining member or the retaining part and the matching part can also be a part that can be bent or elastic to a certain extent, or can be any other structure that can connect the valve core 230 to the base 210, and can destroy the connection under pressure.

In addition, in an embodiment of the present disclosure, optionally, the vent valve 200 further comprises a seal 260 arranged between the valve core 230 and the base 210.

In the normal working state of the battery, that is, in the non-exhaust state of the battery, the valve core 230 is usually in the first position shown in FIG. 4, the first gas channel 231 is blocked by the side wall 212 of the base 210, airflow entering the central channel 211 can be discharged through the breathable membrane 250, but cannot flow through the first gas channel 231. In the abnormal working state of the battery, that is, in the exhaust state of battery, internal pressure rise due to the battery exhaust, and the pressure accumulated to a certain extent causes the connection between the protrusion 237 of the valve core 230 and the hole 214 to “broken”, so that the valve core 230 move to the second position relative to the base 210. In the second position, the first gas channel 231 is fully opened to allow at least part of the airflow to bypass the breathable membrane 250, and in the second position, the valve core 230 can be configured to at least partially maintain connection with the central channel 211, thus avoiding the separation of the valve core 230 from the base 210. FIG. 5 shows an exemplary second position. In this second position, all the first gas channels 231 are no longer blocked, but can allow the airflow to pass through. Therefore, a large amount of air flow entering the central channel 211 can flow through the first gas channel 231, and bypass the breathable membrane 250, so that a large amount of gas can be rapidly discharged in a short time.

Those skilled in the art should understand that although the above embodiments give the specific structure of the retaining member and the retaining part and the matching part, the above embodiments only illustrate the present disclosure by way of example, and other structures that can realize the movable connection between the valve core and the base under the pressure are also included in the scope of the present disclosure. For example, but not limited to, the retaining member can include at least one slide rail connected with one of the valve core and the base, and the other of the valve core and the base has a slide rail joint part corresponding to the slide rail, the slide rail joint part is configured to slide with the slide rail, one of the slide rail and the slide rail joint part includes at least one protrusion, and the other of the slide rail and the slide rail joint part includes at least one recess or hole, the protrusion is configured to engage with the recess or hole to maintain the valve core in the first position. The protrusion can be configured to be separated from the hole when the valve core moves from the first position to the second position relative to the base, so as to realize the movable connection between the valve core and the base under the pressure. In addition, in other embodiments of the present disclosure, the valve core and the base can be joined by a connection that can be removed under a certain gas pressure instead of the retaining member or the retaining part and the matching part. For example, a bonding structure can be formed by adhesive to join the two parts, and under a certain gas pressure, the bonding structure will fail, thus realizing the movement of the valve core relative to the base, as described in other parts of the present disclosure.

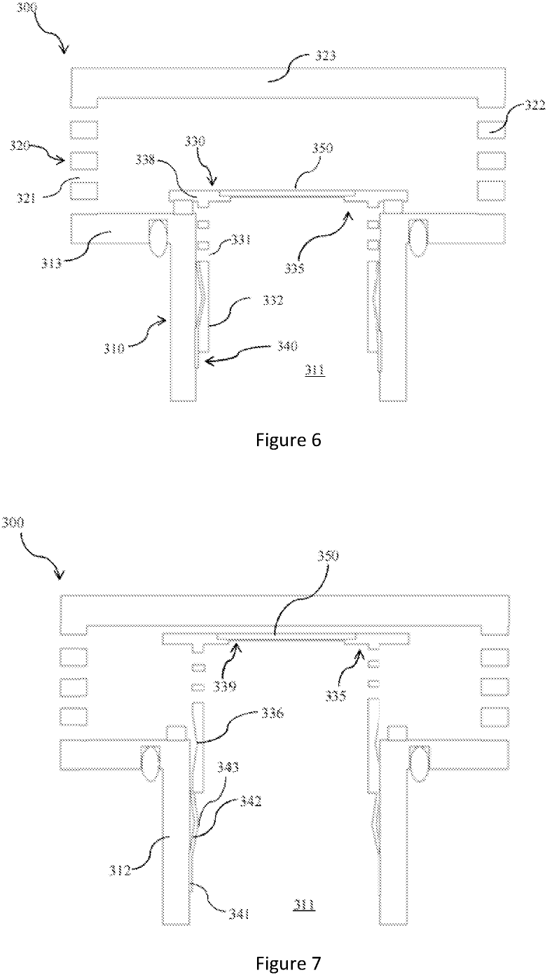

FIGS. 6 and 7 are schematic diagrams of a vent valve 300 including a breathable membrane 350 that can be incorporated into the battery assembly 24 according to another embodiment of the present disclosure. As shown in FIGS. 6 and 7, similar to the vent valve 100, the vent valve 100 may include a base 310 defining a central channel 311 and a valve core 330 movably connected to the base 310. The base 310 may include a side wall 312 and a flange 313 extending from the side wall 312. The flange 113 may be used to connect the vent valve 100 to the battery assembly and/or other components, as described in other parts of the present disclosure.

Unlike the vent valve 100, the vent valve 300 may further include a cover 320 connected to the base 310. The cover 320 may be connected to the flange 313 of the base 210 or integrally formed with the base 310. The cover 320 can be used as a protective part to isolate the outside and the valve core 330. The cover 320 includes at least one second gas channel 321 arranged on it. In the embodiment shown in FIGS. 6 and 7, the second gas channel 321 is arranged on the side wall 322 of the cover 320. However, the second gas channel can be arranged on a top wall 323 of the cover 320 to supplement or replace the second gas channel arranged on the side wall 322 as required. In the embodiment of the present disclosure, the cover 320 can limit the maximum displacement of the valve core 330 relative to the base 310. Therefore, the height of the cover 320 can roughly correspond to or be slightly greater than the height of the valve core 330, so as to ensure that the valve core 330 can maintain the connection with the central channel 311 without being separated from it when it moves to the second position under the action of the gas pressure. However, as required, a cover 320 with a height greater than the height of the valve core 330 can also be provided to allow a larger fluid space outside the central channel 311. In this case, a limit part, such as a stop or a limit connecting wire, can be provided on the base 310 or a retaining member 340 to prevent the valve core 330 from moving away from the central channel 311. Other parts or structures that can realize the limit function are also included in the scope of the present disclosure, and those skilled in the art can adjust tolerance clearance, setting position, etc. between parts or structures as needed to achieve the limit effect.

In addition, the valve core 330 can also have a cover 338, which is connected with the side wall 332 of the valve core 330 and covers an opening 335 of the valve core 330. The cover 338 can include a third gas channel 339 arranged in the middle part, and the breathable membrane 350 can completely cover the third gas channel 339.

Similarly to the valve core 130, the valve core 330 may include a side wall 332 contained in the central channel 311 and at least one first gas channel 331 arranged on the side wall 332. The valve core 330 can be movably connected with the base 310 through an additional retaining member 340, so that the valve core 330 can move from the first position to the second position relative to the base 310 under the gas pressure. In the embodiment of FIG. 6, the retaining member 340 may include a connecting part 341 and an extension part 342 extending from the connecting part 341, and the extension part 342 may have a protrusion 343. The connecting part 341 may be connected to the side wall 312 of the base 310, and the side wall 332 of the valve core 330 may include a recess 336 corresponding to the protrusion 343. The protrusion 343 can be configured to engage with the recess 336 to maintain the valve core 330 in the first position shown in FIG. 6. The recess 336 can be configured to be separated from the protrusion 343 when the valve core 330 moves from the first position to the second position relative to the base 310, as described in other parts of the present disclosure.

When the valve core 330 is in the second position as shown in FIG. 7, the central channel 311, the first gas channel 331 and the second gas channel 321 are in fluid communication. Therefore, under the abnormal working state of the battery, a large amount of airflow entering the central channel 311 can flow through the first gas channel 331, bypass the breathable membrane 350, and discharge from the second gas channel 321, so that a large amount of gas can be rapidly discharged in a short time.

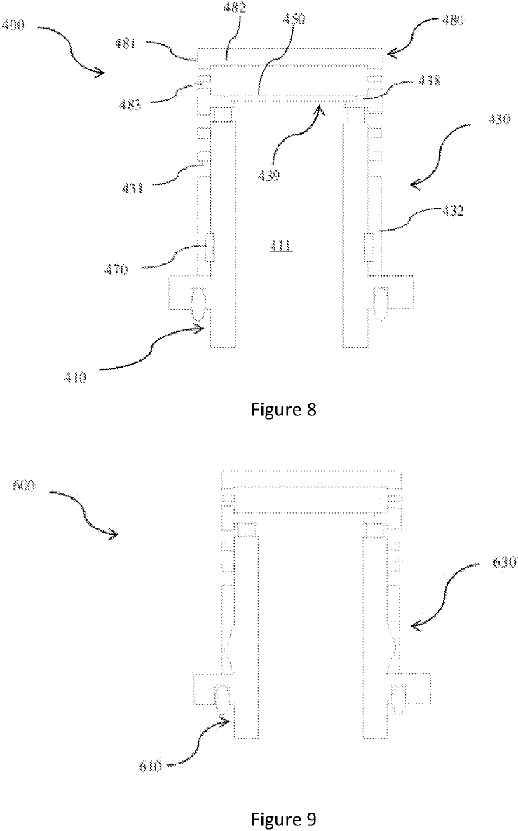

FIG. 8 is a schematic diagram of a vent valve 400 including a breathable membrane 450 that can be incorporated into the battery assembly 24 according to yet another embodiment of the present disclosure. As shown in FIG. 8, similar to the vent valves 100, 200 and 300, the vent valve 400 can include a base 410 defining a central channel 411 and a valve core 430 movably connected with the base 410. Unlike the vent valves 100, 200 and 300, the valve core 430 is connected with the base 410 through an adhesive 470, and the adhesive 470 maintains the valve core 430 in the first position as shown in FIG. 8.

The valve core 430 has a first cover 438, which is connected with a side wall 432 of the valve core 430. The first cover 438 can include a third gas channel 439 arranged in the middle part, and the breathable membrane 450 can completely cover the third gas channel 339. In addition, the valve core 430 can also include a second cover 480 arranged above the first cover 438. The second cover 480 has a side wall 481 and a top 482 connected with the side wall 481, the side wall 481 is connected with the side wall 432, and the side wall 481 of the second cover 480 is provided with a fourth gas channel 483. When the valve core 430 is in the first position as shown in FIG. 8, the gas entering the central channel 411 enters the second cover 480 through the breathable membrane 450 and is discharged through the fourth gas channel 483, thus maintaining the gas pressure balance inside and outside the vent valve. Although it is shown in FIG. 8 that the gas channel is only provided on the side wall 481, the gas channel can also be provided on the top 482 as an alternative or additional way as required.

In the abnormal working state of the battery, that is, in the exhaust state of the battery, internal pressure rise due to the battery exhaust, and the accumulated pressure to a certain extent causes the bonding between the valve core 430 and the base 410 to be “broken”, so that the valve core 430 move to the second position relative to the base 410. In the second position, the first gas channel 431 arranged on the side wall of the valve core 430 is fully opened to allow at least part of the airflow to bypass the breathable membrane 450 and be discharged from the first gas channel 431, so that a large amount of gas can be rapidly discharged in a short time. In addition, in the second position, the valve core 430 can be configured to at least partially maintain the connection with the base 410, so as to avoid the separation of the valve core 430 from the base 410.

FIGS. 9-11 are schematic diagrams of vent valves 600~800 including a breathable membrane that can be incorporated into the battery assembly 24 according to other embodiments of the present disclosure. The vent valves 600~800 have a structure substantially similar to that of the vent valve 400, but the retaining member or the retaining part and the matching part are different.

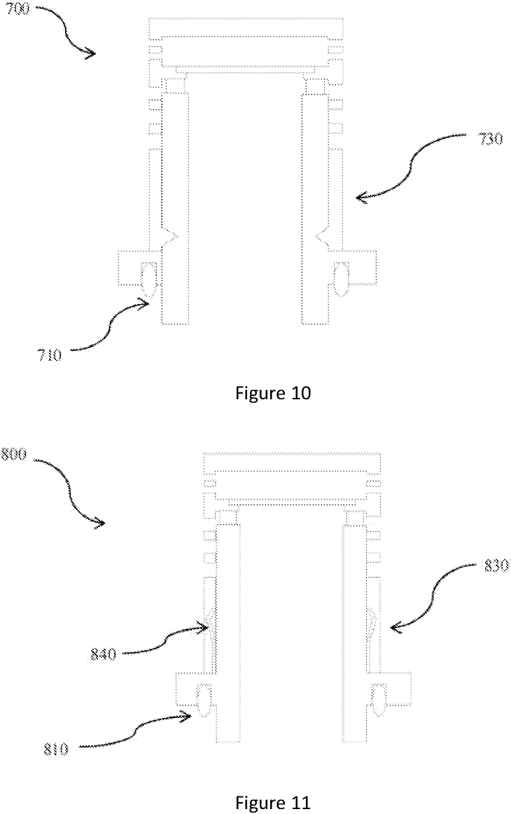

For example, FIG. 9 shows an embodiment in which a side wall of a base 610 is provided with a protrusion and a side wall of a valve core 630 is provided with a recess corresponding to the protrusion. FIG. 10 shows an embodiment in which a side wall of a valve core 730 is provided with a triangular protrusion and a side wall of a base 710 is provided with a recess corresponding to the protrusion. FIG. 11 shows an embodiment in which a side wall of a base 810 is connected or integrally provided with a retaining member 840 and a valve core 830 is provided with a protrusion for accommodating the retaining member 840. It should be understood by those skilled in the art that although FIGS. 9-11 are illustrated with the example that the valve core is provided outside the base, it is also applicable to the case that the valve core is provided inside the base.

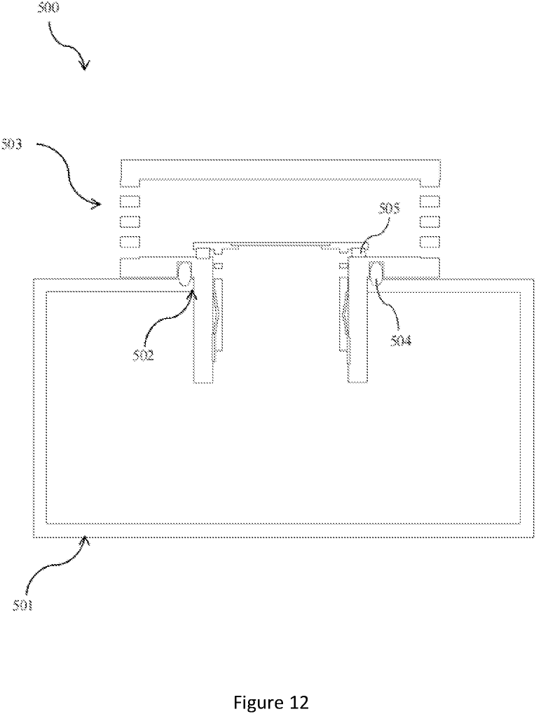

According to another aspect of the present disclosure, a battery assembly 500 is provided. As shown in FIG. 12, the battery assembly 500 can contain a battery cell shell 501, which can be configured to accommodate battery cells (not shown in the figure) and has an opening 502; and a vent valve 503 including a breathable membrane and connected with the battery cell shell 501 through the opening 502. The vent valve 503 can include the vent valve 100, 200 or 300 in the preceding embodiments. In addition, the battery assembly 500 may further comprise a first seal 505 arranged between a valve core and a base and a second seal 504 arranged between the base and the battery cell shell 501. The valve core can be the valve core 130, 230, 330, 430, 630, 730 or 830 in the preceding embodiments, and the base can be the base 110, 210, 310, 410, 610, 710 or 810 in the preceding embodiments. The first seal 505 may be the seal 160 or 260 in the preceding embodiments. The second seal 504 is used to seal mating surfaces between the vent valve and the battery assembly to prevent water vapor or foreign matter from entering the battery assembly.

In the embodiment shown in FIG. 12, the base of the vent valve 503 can be extended into the battery cell shell 501 through the opening 502, and a flange of the base can be placed or fixed on an outer surface of the battery cell shell 501. The second seal 504 can be arranged between the flange and the battery cell shell 501. The flange of the base may be the flange 113, 213 or 313 in the preceding embodiment.

In some examples, the vent valve 503 can be a replaceable part. When the valve core moves from the first position to the second position under the gas pressure, the vent valve can be replaced with a new vent valve as a whole to avoid the replacement of the whole battery assembly.

According to yet another aspect of the present disclosure, a vehicle is provided, which may include a battery assembly as described in the preceding embodiment.

It should be understood that, all the embodiments, features and advantages described above for the vent valve according to the present disclosure are equally applicable to the battery assembly and vehicle according to the present disclosure, as long as they do not conflict with each other. That is to say, all embodiments and their variants of the vent valve described above can be directly transferred and applied to the battery assembly and vehicle according to the present disclosure, and directly combined with it. For the sake of brevity of the present disclosure, it will not be repeated here.

To sum up, the present disclosure proposes a vent valve including a breathable membrane. The vent valve can used with a battery assembly and a vehicle. The scheme of the present disclosure can effectively and rapidly release the battery exhaust under the abnormal working state of the battery, that is, the exhaust state of the battery, and thus effectively relieve the internal pressure accumulation caused by the battery exhaust. In addition, the vent valve of the present disclosure facilitates installation and operation.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vent valve including a breathable membrane, comprising:
a base defining a central channel; and
a valve core having a breathable membrane and at least one first gas channel, the valve core movably connected with the base, the valve core configured to move from a first position to a second position relative to the base in response to gas pressure, when the valve core is in the second position, the at least one first gas channel is at least partially opened to allow flow to bypass the breathable membrane.

2. The vent valve according to claim 1, further comprising a cover connected with the base and including at least one second gas channel, wherein, when the valve core is in the second position, the central channel, the first gas channel and the second gas channel are in fluid communication.

3. The vent valve according to claim 2, wherein the cover limits displacement of the valve core relative to the base.

4. The vent valve according to claim 1, wherein the valve core has a side wall contained in the central channel and an opening surrounded by the side wall, wherein the breathable membrane covers the opening, wherein the first gas channel is formed on the side wall.

5. The vent valve according to claim 4, wherein the valve core comprises a first end formed by extension of the side wall, the first end configured to move away from the base while the valve core moves from the first position to the second position relative to the base, wherein the first gas channel is arranged on the side wall of the valve core near the first end.

6. The vent valve according to claim 4, wherein the valve core is configured to at least partially maintain connection with the central channel when it is in the second position.

7. The vent valve according to claim 1, further comprising a retaining member, the valve core movably connected with the base through the retaining member, the retaining member configured to maintain the valve core at least in the first position.

8. The vent valve according to claim 7, wherein the retaining member comprises a connecting part and an extension part extending from the connecting part, the extension part having at least one protrusion, wherein the connecting part is connected to one of the valve core or the base, wherein the other of the valve core or the base includes at least one recess corresponding to the at least one protrusion, the protrusion is configured to engage with the recess to maintain the valve core in the first position.

9. The vent valve according to claim 8, wherein the recess is configured to be separated from the protrusion when the valve core moves from the first position to the second position relative to the base.

10. The vent valve according to claim 1, wherein one of the valve core or the base includes a retaining part, and the other of the valve core or the base includes a matching part corresponding to the retaining part.

11. The vent valve according to claim 10, wherein the retaining part and the matching part are configured to maintain the valve core at least in the first position through interference fit or friction fit.

12. The vent valve according to claim 1, further comprising a seal arranged between the valve core and the base.

13. The vent valve according to claim 1, wherein the valve core is configured to moves in a first direction relative to the base, and, when the valve core is in the second position, at least part of the flow flows through the first gas channel in a second direction different from the first direction.

14. The vent valve according to claim 13, wherein the first direction is perpendicular to the second direction.

15. A battery assembly, comprising:
a battery cell shell configured to accommodate battery cells, the battery cell shell having an opening; and
a vent valve including a breathable membrane, the vent valve connected with the battery cell shell through the opening, wherein the vent valve comprises:
a base defining a central channel; and
a valve core movably connected with the base and including at least one first gas channel, the valve core is configured to move from a first position to a second position relative to the base in response to a gas pressure, wherein, when the valve core is in the second position, the first gas channel is at least partially opened to allow airflow to bypass the breathable membrane.

16. The battery assembly according to claim 15, wherein the vent valve further comprises a cover connected with the base and including at least one second gas channel, wherein, when the valve core is in the second position, the central channel, the first gas channel and the second gas channel are in fluid communication.

17. The battery assembly according to claim 15, wherein the vent valve further comprises a retaining member, the valve core movably connected with the base through the retaining member, the retaining member configured to maintain the valve core at least in the first position.

18. The battery assembly according to claim 15, further comprising:
a first seal arranged between the valve core and the base; and
a second seal arranged between the base and the battery cell shell.

19. A vehicle including the battery assembly of claim 15.
